(19) United States
(12) Patent Application Publication
(10) Pub. No.: US 2014/0144063 A1
(43) Pub. Date: May 29, 2014

(54) INTERCHANGEABLE BAIT HEAD AND SYSTEM FOR ARTIFICIAL BAIT

(71) Applicant: Robert Buck Hamilton, JR., Jackson, MS (US)

(72) Inventor: Robert Buck Hamilton, JR., Jackson, MS (US)

(21) Appl. No.: 14/091,852

(22) Filed: Nov. 27, 2013

Related U.S. Application Data
(60) Provisional application No. 61/731,435, filed on Nov. 29, 2012.

(51) Int. Cl. A01K 85/00

(52) U.S. Cl. CPC A01K 85/00
USPC 43/4.5; 43/42.09; 43/42.37; 43/42.32

(57) ABSTRACT

A fishing lure for fishing in a body of water including a head having a proximate end and a distal end, the head having a chamber therein communicating with an opening in its distal end and a hook through the proximate end of the head. A hook extends through the chamber from the proximate end of the head and through the opening of the distal end. The hook has an eye for connecting to a fishing line. Artificial bait is disposed on the hook and extends into the chamber in the head. The head is shaped for imparting oscillating side-to-side movement to the head relative to the bait and hook as the lure moves through water.

### FIELD OF THE INVENTION

This invention relates to fishing lures, and more particularly to bait head which, when coupled with artificial bait, imparts a desired movement to the bait as it moves through the water.

### BACKGROUND OF THE INVENTION

Many different tactics and lures are available to allow a fisherman to catch fish that live in different habitats and exhibit different habits. It is common for serious fishermen to purchase dozens or even hundreds of different lures to be used in different situations.

Present lures are designed to be cast into the water and then are allowed to fall to a desired depth or to the bottom of a body of water at the end of an attached fishing line. The fisherman then reels the lure in either along the bottom of the body of water or at a preferred depth. If a certain depth is preferred, the fisherman has to judge the depth of the fall and begin reeling the line in to get horizontal movement to attract fish before the lure falls out of the preferred range. Different lures can be selected to alter this pattern, as may be desired. However, fish appear to be less likely to strike as they have become familiar with and adjusted to the movement patterns of known lures, making it harder for a fisherman to catch a fish using lures that exhibit that pattern.

U.S. Pat. No. 4,450,645 issued May 29, 1984 to Ancona for BOTTOM FISHING LURE discloses a bottom fishing lure having a fish hook and a weighted, non-buoyant head adapted to be pulled head first along the bottom surface of a body of water by a fishing line and adapted to carry a trailing bait. The disclosed lure has a series of resilient legs extending radially from the head designed to impart a forward walking motion accompanied by a lateral waggling of the hook and bait. The length of the legs and the weight distribution of the head are selected to encourage the hook to walk in a position with its point elevated well above the bottom.

U.S. Pat. No. 4,769,904 issued Sep. 13, 1988 to Doss for SPINNER BAIT WITH AN IMPROVED LIP MEMBER discloses a spinner bait having a hook, head and an improved lip member which causes the bait to dive and run deep while maintaining the bait balance thus eliminating rolling and tumbling. The angle which the lip portion forms with the longitudinal axis of the bait head can be adjusted to vary the depth of the run.

U.S. Pat. No. 6,061,948 issued May 16, 2000 to Boucek for ADAPTABLY MOUNTABLE HEAD WITH EYE FOR ATTACHMENT TO FISHING LURES discloses an adaptably mountable head that is adapted to be fitted or coupled to a presently exiting or common fishing lure, such as a worm and hook fishing lure. The head portion has a hollow receiving chamber. The head is secured to a fishing lure having a soft plastic animal fishing lure in place to a fishing hook. Various colored eyes are painted on or fixedly attached to different head portions to resemble the heads and eyes of bait animals upon which fish prefer to prey.

U.S. Pat. No. 6,718,683 B2 issued Apr. 13, 2004 to Hawkins for REUSABLE SIMULATED BAIT FISH WITH INSERTABLE HEAD AND HOOK discloses a hook and torpedo head weight to be inserted through a narrow passageway into a cavity shaped to receive the weight in a cast rubber simulation of a live bait. The head is molded in a variety of sizes and weights to match fish components and to account for the versatility for fishing the lure in shallow or deep waters. The bait lure simulates the look, posture, and motion of the live bait.

U.S. Pat. No. 7,076,911 B2 issued Jul. 18, 2006 to Thorne for SOFT BODY COVERED SWIMMING-JIG FISHING LURE, discloses a fishing lure constructed from a swimming jig and cover for the swimming jig. The cover has a pair of tilted fins which produce a unique fish attracting and catching action as the fishing lure is displaced through water.

U.S. Pat. No. 7,963,066 B2 issued Jun. 21, 2011 to Perrick for FISHING LURE and discloses a fishing lure that includes a bait head, bait body and an attachable action lip, there the lure can provide a realistic swimming action or a twitching or jerking motion when used for jigging.

### SUMMARY OF THE INVENTION

The present invention includes an interchangeable bait head fishing system which allows a fisherman to make a large number of distinct lures with a small number of pieces. Another object of the present invention is to provide a bait head system that moves through the water in a desired fashion. Another object of the present invention provides a system that may be quickly changed to have either a heads down attitude or a heads up attitude in the water, as desired. Another object of the present invention is to impart a horizontal, oscillating or back-and-forth motion as water flows over the bait head as the bait head moves through the water, either as the lure falls toward the bottom of the body of water, or as the lure is pulled through the water. It is a further object of the present invention is to impart either a tail first or head first movement to the system as water flows over the lure of the present system as the lure free falls toward the bottom of the body of water.

Methods are described and claimed for the objects of the present invention.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a top view of a first embodiment of the head of a fishing lure of the invention;

FIG. 2 is a bottom view of the embodiment of FIG. 1;

FIG. 3 is a side view the embodiment of FIG. 1;

FIG. 4 is a top view of a second embodiment of the head of a fishing lure of the invention;

FIG. 5 is a bottom view of the embodiment of the embodiment of FIG. 4;

FIG. 6 is a side view to the embodiment of FIG. 4;

FIG. 7 is a top view of a third embodiment of the head of a fishing lure of the invention;

FIG. 8 is a side view of the embodiment of FIG. 7;

FIG. 9 is a front view of the embodiment of FIG. 7;

FIG. 10 is a fish hook of the fishing lure of the invention; and

FIG. 11 is a weight of the fishing lure of the invention.

The detailed description explains the preferred embodiments of the invention, together with advantages and features, by way of example with reference to the drawings.

### DETAILED DESCRIPTION OF THE INVENTION

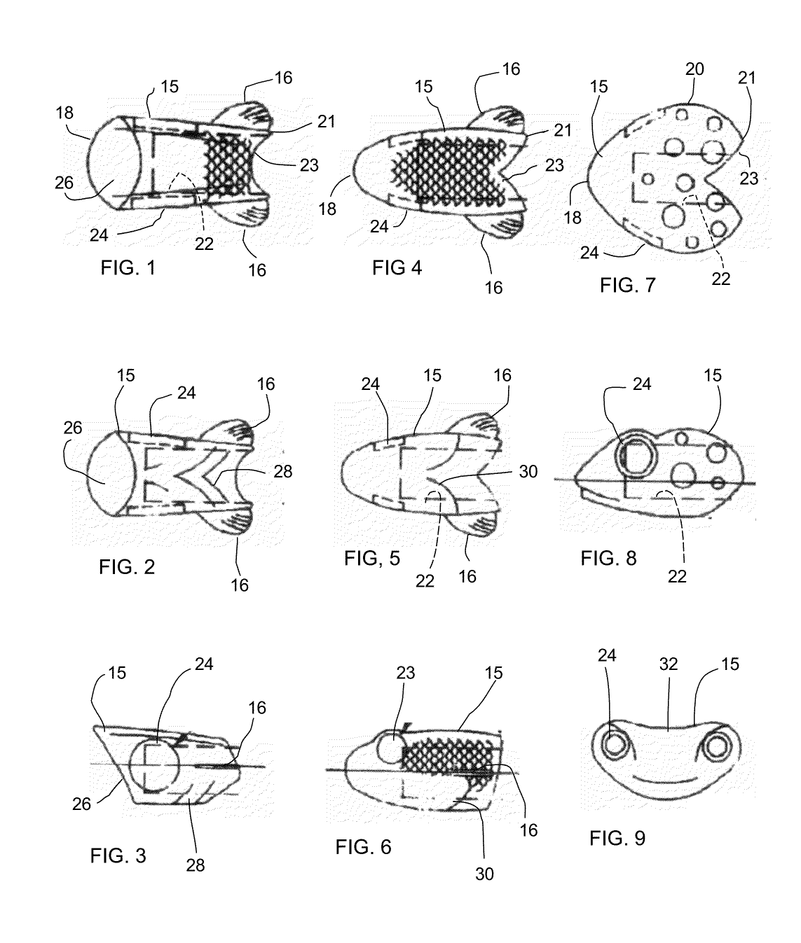

FIGS. 1, 4 and 7 are embodiments of the head 15 of the fishing lure of the present invention wherein the same elements of the embodiments are given the same numbers. The embodiments of FIGS. 1 and 4 have fins extending from the sides of the head 15. The head 15 of each of the embodiments has a nose at the front or proximate end 18 and a back or distal end 21. In the embodiment of FIG. 7, the head 15 has a torpedo shape extending form the nose 18 to its widest point 20, and then decreasing in width to its distal end 21. The head 15 of each of the embodiments has a chamber 22 which communicates with an opening 23 in the back of the head 15. The chamber is sized to receive an artificial lure (not shown) such as a plastic worm or creature baits, tubes or grubs or other artificial lure, such as are well known. The color of the head 15 and the artificial lure may be changed easily in different combinations, as desired, to tailor the appearance and color of the lure without carrying a large number of different colored lures in different combinations. The head 15 of each of the embodiments has large eyes 24 on the sides of the head 15. The eyes 24 are painted or colored in contrasting colors to the head in order that the fisherman my see the lure as is descends in the water to judge the location and depth of the lure.

The head 15 of the first embodiment has a scoop mouth at the front or proximate end 18 of the head 15 and ribs 28 formed on the bottom of the head 15. The head 15 of the second embodiment has a torpedo shape with sides that taper to form external ribs 30. The third embodiment has a narrowed portion 32 between the eyes 24 and has a torpedo shape with a wider portion 20 tapering to a less wide portion 21 at the back or distal end 21 of the head 15. Each of these features are designed to cause shimmy or oscillating motion between the head 15 and the artificial lure, one end of which is positioned in the chamber 22 of the head 15 as the lure of the present invention moves through the water. As us well known. Many fish have sensing organs called lateral lines such that these fish can sense prey from vibrations and pressure waves in the water coming from the prey, even if the fish can't see the prey. The initial drop of the lure in the water and the shimmy and lateral oscillations of the lure as it descends or is pulled through the water causes pressure changes that fish can sense with its lateral line organs. The shimmy or vibrations of the lure of the present invention takes advantage of the way fish sense their prey to make the lure more “visible” to fish, even in murky or dark water conditions.

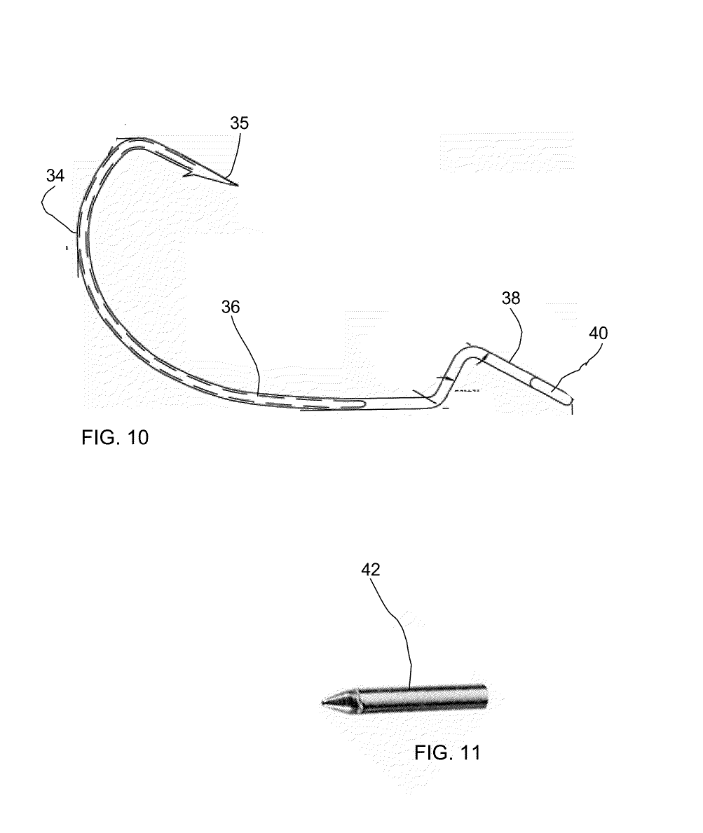

FIG. 10 is a side view of a fish hook 34 having a barbed pointed end 35, a curved portion 36, and a straight portion oriented to be inline with the barbed point 35. At the end of the straight portion 28 is an eye 40 through which a fishing line may be attached. The head 15 may be made of a soft elastomeric material the same or similar to that of the artificial bait, such as a plastic worm, such that the barbed end 25 may be pushed through the nose 18 of the head 15 and into the chamber 22. The head 15 may then be slidibly positioned on the hook 34 until only the eye 40 extends from the nose 18 so that a fishing line may be tied to the eye. FIG. 42 is a weight 42 that may be positioned, for instance, along the curved portion 36 to give the lure the desired buoyancy and attitude. The weight may be a split weight which is placed over and crimped on the hook 34 in the position desired. The barbed end of the hook is then pushed through the artificial bait, and the end of the bait in slidibly located on the hook until the end is inserted into the chamber 22. The weight 42 is sized and located on the hook such that the lure has a positive buoyancy such that it floats in the water, or is has a negative buoyancy such that it sinks to the bottom of the body of water, or has a neutral buoyancy at a desired depth such that the lure stays at the desired depth. Further, the chamber may be sized to trap air therein as the artificial bate is dispose therein to further add to the buoyancy of the lure. The weight 42 may further be located on the hook such that the lure has a head-up attitude, or a head-down attitude. When the lure is dropped in the water, such as when fishing from a pier or floating dock, depending on the attitude of the lure, the lure will move laterally as the lure moves downwardly in the water, so that the lure may move laterally under or away from the pier or dock as the lure descends, as desired. This provides that the lure may be positioned under a pier or dock without trying to cast the lure under the pier or dock. It will be understood that as the lure descends, it will shimmy or oscillate to be more lifelike, which is more attractive to fish.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

I claim:

1. A bait head for fishing in a body of water comprising:
a head portion having a proximate end and a distal end, said head portion having a chamber therein communicating with an opening in said distal end, said head for receiving a hook through the proximate end and extending through said chamber from said proximate end of said head portion through the opening of said distal end and having an eye for connecting to a fishing line, said chamber for receiving bait disposed on the hook, said head portion having provision thereon for imparting oscillating side-to-side movement to said head portion relative to the bait and hook as said head portion moves through water.

2. The bait head of claim 1 wherein said chamber is of sufficient size to trap air when the bait disposed on the hook is located in said chamber such that the head portion and bait has positive buoyancy, neutral buoyancy, or negative buoyancy when the bait head is disposed in the body of water, depending on weighting of the hook.

3. The bait head of claim 2 wherein said head portion has a head-up or a head-down attitude when disposed in water.

4. The bait head of claim 1 wherein the head portion moves in a forward direction toward the proximate end or in a backward direction toward the distal end depending of how the hook is weighted as the bait heads falls toward the bottom of the body of water.

5. The bait head according to claim 1 wherein said head portion has eyes thereon such that the bait head may be better seen at the surface of the body of water even when the water is murky.

6. The bait head according to claim 1 wherein said head portion is made of the same material as soft plastic bait such as any of worms, creature baits, tubes and grubs.

7. A fishing lure for fishing in a body of water comprising:
a head having a proximate end and a distal end, said head having a chamber therein communicating with an opening in said distal end,
a hook through the proximate end of said head and extending through said chamber from said proximate end of said head through the opening of said distal end, said hook having an eye for connecting to a fishing line,
bait disposed on the hook and extending into the chamber in said head,
said head having provision thereon for imparting oscillating side-to-side movement to said head relative to the bait and hook as said lure moves through water.

8. The lure of claim 7 wherein said chamber is of sufficient size to trap air when the bait disposed on the hook is located in said chamber,
a weight attached to said hook such that the lure has positive buoyancy, neutral buoyancy, or negative buoyancy when the lure is disposed in the body of water.

9. The lure of claim 8 wherein said weight is attached to said hook such that said lure has a head-up or a head-down attitude when disposed in water.

10. The lure of claim 7 wherein the lure moves in a forward direction toward the proximate end of the head or in a backward direction toward the distal end of the head depending of how the hook is weighted as the lure falls toward the bottom of the body of water.

11. The lure according to claim 7 wherein said head has eyes thereon such that the lure may be better seen at the surface of the body of water even when the water is murky.

12. The lure according to claim 7 wherein said head is made of the same material as soft plastic bait such as any of worms, creature baits, tubes and grubs.

13. A method for fishing in a body of water comprising:
providing a head having a proximate end and a distal end, said head having a chamber therein communicating with an opening in said distal end,
passing a hook through the proximate end of said head and extending through said chamber from said proximate end of said head through the opening of said distal end, said hook having an eye for connecting to a fishing line,
disposing bait on the hook extending into the chamber in said head,
said head having provision thereon for imparting oscillating side-to-side movement to said head relative to the bait and hook as said lure moves through water.

14. The method of claim 13 wherein said chamber is of sufficient size to trap air when the bait disposed on the hook is located in said chamber,
attaching a weight to said hook such that the lure has positive buoyancy, neutral buoyancy, or negative buoyancy when the lure is disposed in the body of water.

15. The method of claim 14 wherein said weight is attached to said hook such that said lure has a head-up or a head-down attitude when disposed in water.

16. The method of claim 13 wherein the lure moves in a forward direction toward the proximate end of the head or in a backward direction toward the distal end of the head depending of how the hook is weighted as the lure falls toward the bottom of the body of water.

17. The method according to claim 13 wherein said head has eyes thereon such that the lure may be better seen at the surface of the body of water even when the water is murky.

16. The method according to claim 13 wherein said head is made of the same material as soft plastic bait such as any of worms, creature baits, tubes and grubs.
